(19) United States
(12) Patent Application Publication
(10) Pub. No.: US 2013/0092330 A1
(43) Pub. Date: Apr. 18, 2013

(54) LOW FRICTION CURTAIN DOOR STRIPPING

(71) Applicants: Edward S. Robbins, III, Muscle Shoals, AL (US); Ronald R. White, Florence, AL (US); Harry L. Raney, Florence, AL (US); Bailey J. Black, JR., Florence, AL (US)

(72) Inventors: Edward S. Robbins, III, Muscle Shoals, AL (US); Ronald R. White, Florence, AL (US); Harry L. Raney, Florence, AL (US); Bailey J. Black, JR., Florence, AL (US)

(21) Appl. No.: 13/273,601

(22) Filed: Oct. 14, 2011

(51) Int. Cl. A47H 23/05; B32B 3/30

(52) U.S. Cl. 160/332; 428/167

(57) ABSTRACT

An industrial traffic curtain can be formed of a plurality of overlapping strips suspended contiguously to each other from a hanger fixed adjacent to a top margin of the opening. Each strip is of a flexible transparent material of substantially uniform longitudinal character having a lateral cross-section defined by an alternating series of thicker portions separated from each other by thinner portions, the thicker and thinner portions having approximately the same width, the thinner and thicker portions being united by narrower tapered regions of changing thickness. The traffic curtain thus formed exhibits a surprisingly lower electrostatic attraction between the strips so that the resistance to separation from each other as goods and transporting vehicles attempt to pass through the curtain is much lower than prior art curtains.

### BACKGROUND

The present invention relates generally to industrial curtains used as environmental closures for openings through which traffic can still pass. The curtains generally comprise a plurality of strips suspended contiguously to each other from a hanger fixed adjacent to a top margin of the opening, each strip consisting essentially of a length of flexible material terminating adjacent to a lower margin of the opening. The present invention relates particularly to an improved configuration for the material forming the strips of such industrial curtains so that the electrostatic interaction between the strips is minimized.

Goods are often required to be transported from one area of a manufacturing or storage facility to another where one or the other of the areas is heated, air-conditioned or even refrigerated. Sometime other environmental concerns need to be addressed such as dust, fumes, smoke, dirt, or even noise. Where the traffic is only occasional, conventional doors can be employed to close any doorway between the two areas. Where the traffic is considerable, the use of conventional doors gives way to suspended flexible screens or curtains that inhibit the wholesale transfer of heated or cooled air from one area to the other yet still permit goods-transporting vehicles to pass through with little effort. Early screens were sometimes made of rubber as shown, for example, in U.S. Pat. No. 2,122,532. For safety reasons, it is desirable that the curtain be sufficiently transparent that one operating a transporting vehicle be able to see any hazard or obstruction that might exist on an opposite side of a screen before proceeding through. Persons on the opposite side of a screen also desire to be able to see oncoming transport vehicles so appropriate evasive action can be taken. Thus, plastic materials, which were more or less transparent, such as polyvinyl chloride and polyethylene, were adopted as the preferred materials for forming such screens as shown, for example, in U.S. Pat. Nos. 4,086,950; 4,095,642; 4,165,778; 4,232,725; 4,289,190; 4,367,781; 4,607,678; 5,127,460; 6,394,171; and 6,933,030.

Plastics such as polyethylene and polyvinyl chloride have two characteristics that have been recognized as detrimental to completely satisfactory performance in industrial doorway curtains. First, the plastic strips are often electro-statically attracted to each other so that they resist separation from each other as the goods and transporting vehicles attempt to pass through the curtain. This problem is particularly evident with the curtain is initially installed. Second, the plastics are generally much softer than the edges and corners of the transporting vehicles and goods packages that pass through the curtains. Thus, the curtain strips quickly become scuffed and scratched by the passing traffic to the point that the originally transparent strips become effectively opaque. In attempting to solve both of these and other related problems special overlapping attachments have been added to the strips, the edges of the strips have included bulbous enlargements, and ridges have been added to the body of the strips as shown, for example, in U.S. Pat. Nos. 4,086,950, 4,289,190 and 6,394,171. Despite these attempts to solve the problems of electrostatic attraction and visibility, the problems remain.

### SUMMARY

The present curtain strips attempt to directly address the problem of preventing scuffing and scratching of the strips of plastic forming the curtain thus ensuring substantially transparency of the strips and ensuring that vision through the strip is unimpeded while at the same time forming a curtain of minimal cost. A surprising and unexpected benefit has been observed in the present curtain strips of a demonstratively lower electro-static attraction to each other so that the frictional resistance to separation from each other as the goods and transporting vehicles attempt to pass through the curtain is much lower than prior art curtains.

The curtain strips can be formed to have a periodic variation in thickness in the width direction when viewed in cross-section comprising an alternating series of thicker portions separated from each other by thinner portions. The thicker portions can be of approximately the same width as the thinner portions. The thinner and thicker portions are united by narrower tapered regions of changing thickness. The narrower tapered regions of changing thickness can have a width of about ¼^{th} the width of either the thinner or thicker portions. The thickness of the thicker portions can be about twice the thickness of the thinner portions. The lateral edges of the curtain strips are preferably of the same thickness as the thicker portions of the remainder of the strip. The curtain strips can be formed of any length appropriate for the dimensions of the doorway or other opening in which the strip curtain is to be deployed.

The strips consist essentially of a length of a flexible, substantially transparent material, such as polyvinyl chloride, having the desired longitudinal cross-section, which can be manufactured by way of a conventional extrusion process. The curtain strips can be assembled in an overlapping fashion as is conventional in such strip curtains. When such a strip curtain is constructed and deployed, a surprising effect is achieved of a demonstratively lower electro-static attraction between the strips so that the resistance to separation from each other as goods and transporting vehicles attempt to pass through the curtain is much lower than prior art curtains. Over time, the thicker areas of the curtain strips are observed to experience most of the frictional scuffing and wear while the thinner areas remain substantially transparent so as to give the curtain the desired visibility.

Other features of the present curtain strips and the corresponding advantages of those features will be come apparent from the following discussion of a preferred embodiment, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 is a perspective view of an industrial curtain installation in which the present strip material can be employed.

FIG. 2 is a front elevation view of a strip of the material forming the curtain shown in FIG. 1.

FIG. 3 is an end view of the material shown in FIG. 2 showing the lateral cross-section of the material forming the strip.

FIG. 4 is an enlarged detail view of a portion of the view shown in FIG. 3.

FIG. 5 is a graph of the force necessary to overcome the electrostatic attraction of various 8″ wide strips forming an industrial traffic curtain.

FIG. 6 is a graph of the force necessary to overcome the electrostatic attraction of various 12″ wide strips forming an industrial traffic curtain.

FIG. 7 is a front elevation view of a prior-art strip of material use in the comparative tests shown in FIGS. 5 and 6.

FIG. 8 is an end sectional view of the material shown in FIG. 7.

FIG. 9 is a front elevation view of another prior-art strip of material use in the comparative tests shown in FIGS. 5 and 6.

FIG. 10 is an end sectional view of the material shown in FIG. 9.

### DESCRIPTION OF PREFERRED EMBODIMENTS

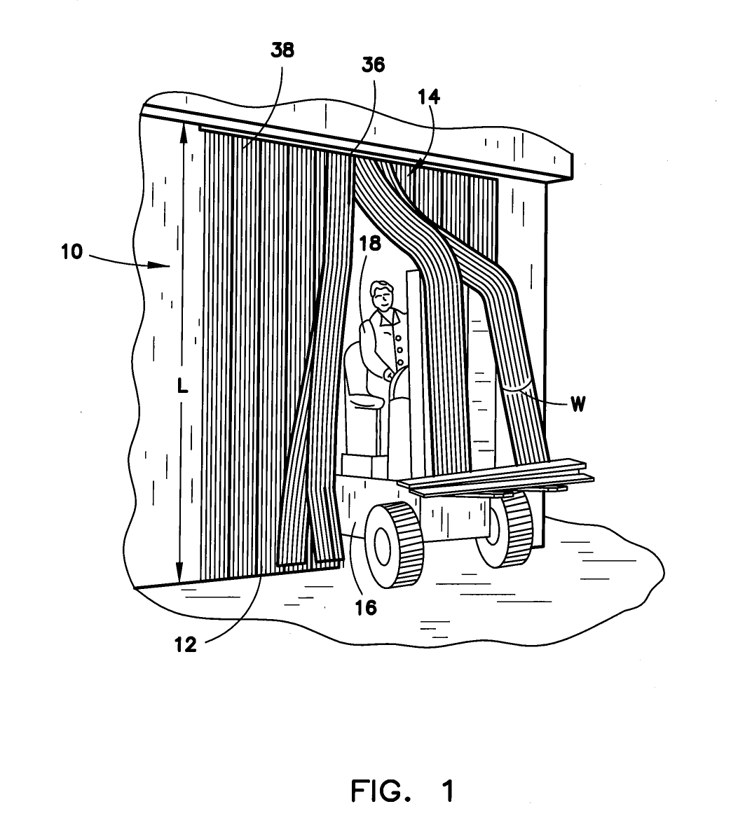

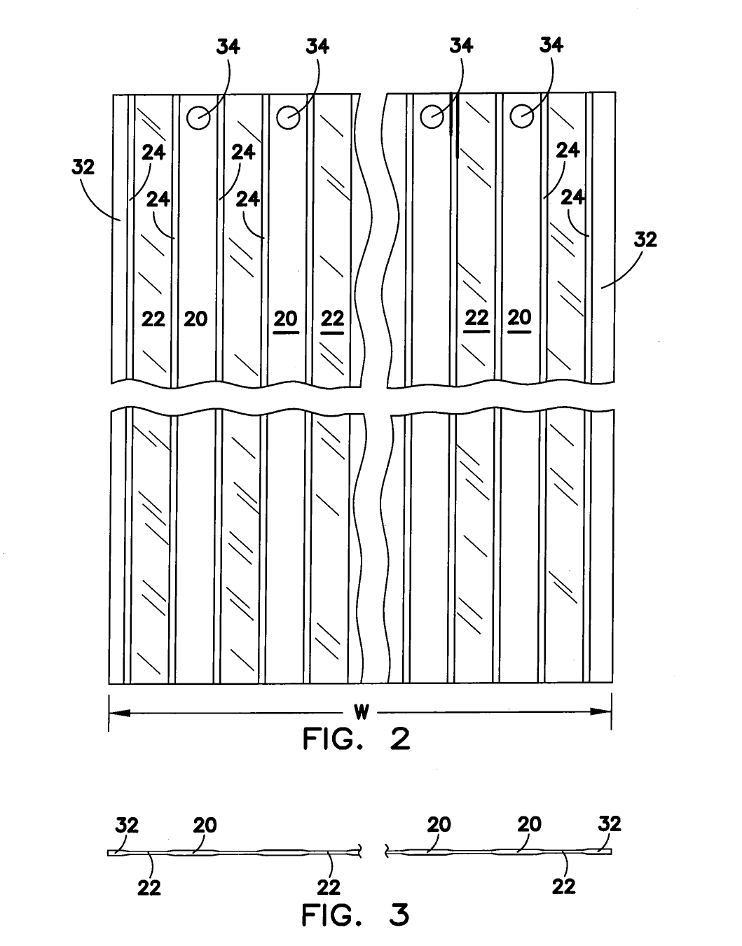

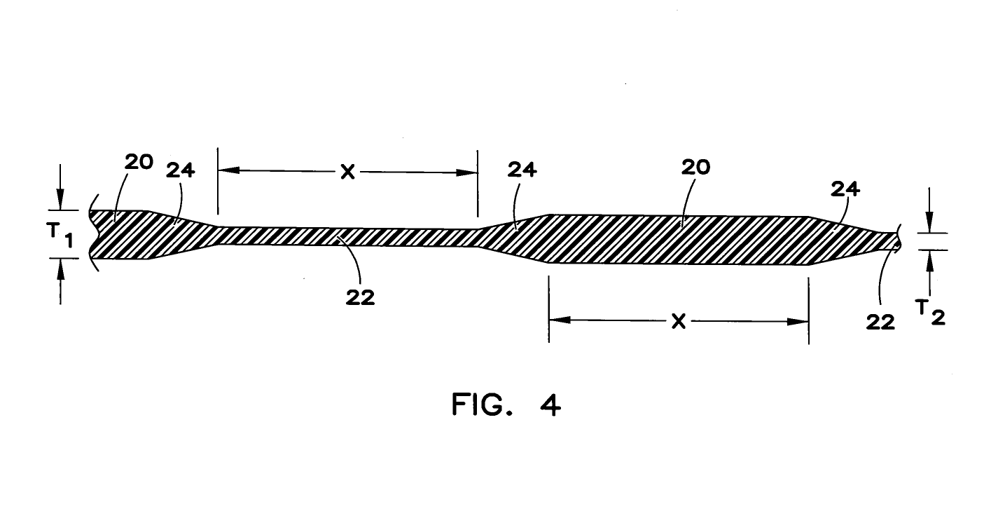

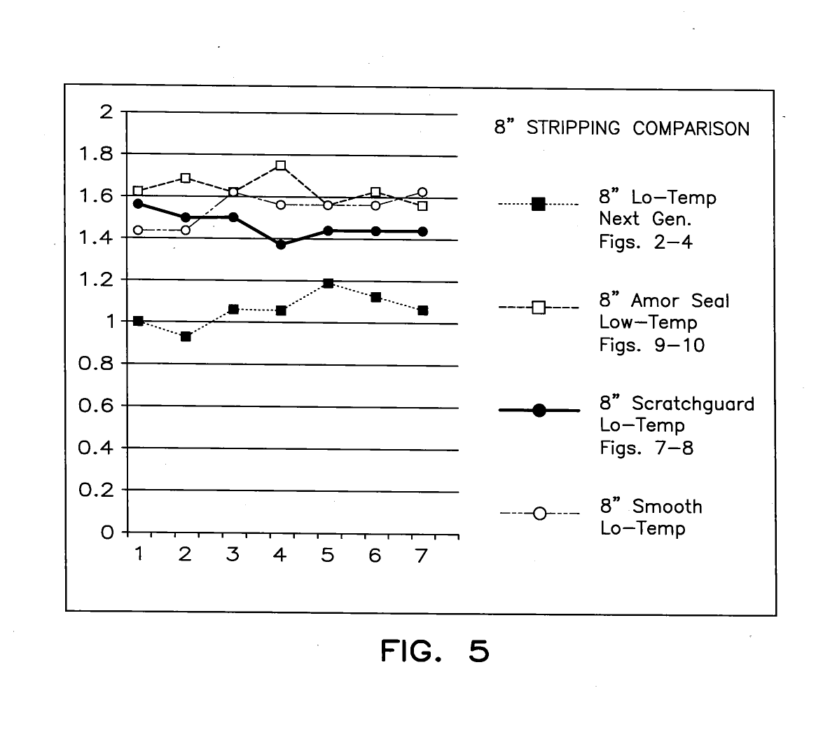

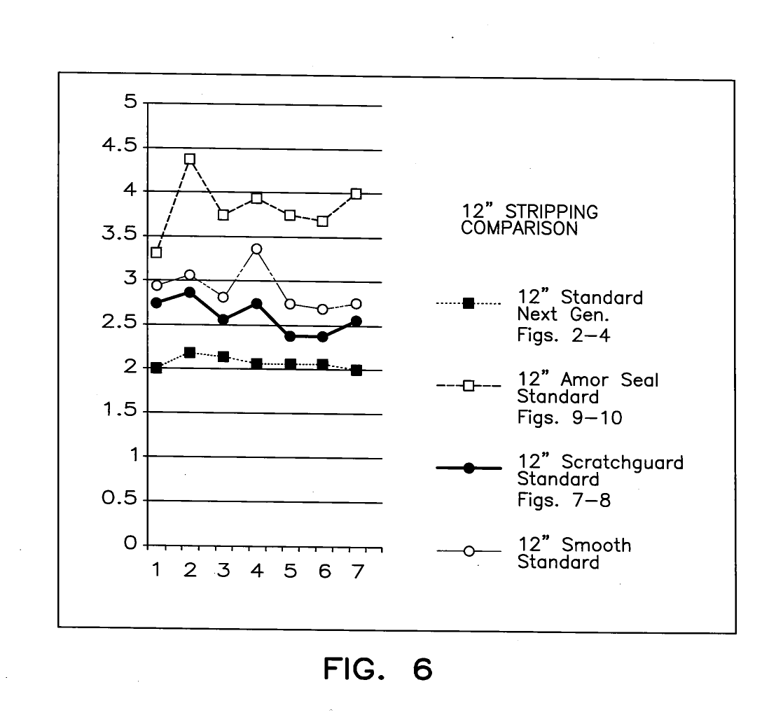

An industrial traffic curtain 10 comprising a plurality of individually suspended strips 12 is shown installed in a doorway or opening 14 in FIG. 1. The individual strips 12 consist essentially of a length L, as needed, of a flexible transparent plastic material, such as polyvinyl chloride, having a substantially uniform width W and a uniform longitudinal cross-section as shown and described in connection with FIGS. 2-4. The width W of the strips 12 can be any dimension, but are typically fixed at two inch increments between about 6 and 16 inches. The strips 12 of plastic material can be formed by a conventional extrusion process. The strips 12 are intended to be sufficiently transparent that an on-coming goods transporting vehicle 16 would be generally visible through the curtain 10. The strips 12 are also intended to be sufficiently transparent that an operator 18 of such a goods transporting vehicle 16 would be able to survey the area on a far side of the curtain 10 before proceeding through the doorway 14. The substantially transparent character of the curtain 10 is only slightly reduced by the presence of more than one layer of strips 12.

As shown in FIGS. 2-4, each strip 12 is formed to have a substantially uniform longitudinal character. Each strip 12 is also formed to have a lateral cross-section defined by an alternating series of thicker portions 20 separated from each other by thinner portions 22. The thicker and thinner portions 20, 22 have approximately the same width x. The thicker portions 20 have a thickness T₁, which can be about 2 mm. The thinner portions 22 have a thickness T₂, which can be about 1 mm. The thinner and thicker portions 20, 22 are united by narrower tapered regions 24 of changing thickness. The thicker portions 20 can have a width to thickness ratio x/T₁ of about 10. The thinner portions 22 can have a width to thickness ratio x/T₂ of about 20. The tapered regions 24 can form about 20% of the width w of the strip 12. The tapered regions 24 can have surfaces 26 that are inclined at an angle of about 10° with respect to the surfaces 28 and 30 forming the thicker and thinner portions 20, 22, respectively. The strip 12 can be formed to have lateral edge portions 32 that have the same thickness as the thicker portions 20. A series of holes 34 can be provided at the top of each strip 12 to engage a hanger 36 fixed adjacent to a top margin 38 of an opening 14 such as is shown in FIG. 1.

When a strip curtain 10 is constructed and deployed using the strips 12 shown in FIGS. 2-4, a surprising effect is achieved of a demonstratively lower electrostatic attraction between the strips 12 so that the resistance to separation from each other as goods and transporting vehicles 16 attempt to pass through the curtain 10 is much lower than prior art curtains. Table I records the force required to pass through a curtain formed of various 8 inch wide strips. Table II records the force required to pass through a curtain formed of various 12 inch wide strips.

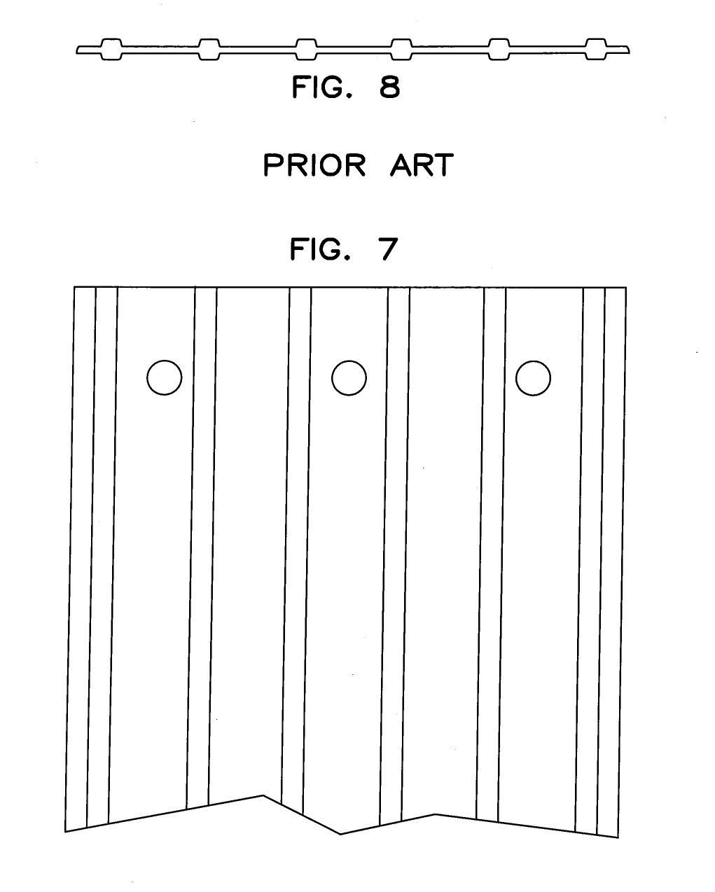

TABLE I
Measured Force in Ounces to Overcome
Electrostatic Attraction in Various 8 inch Wide Strips

| Test | Strips of | Strips of | Strips of FIGS. | Smooth |
|---|---|---|---|---|
| Number | FIGS. 2 - 4 | FIGS. 7 and 8 | 9 and 10 | surface strips |
| 1 | 16 | 25 | 26 | 23 |
| 2 | 15 | 24 | 27 | 23 |
| 3 | 17 | 24 | 26 | 26 |
| 4 | 17 | 22 | 28 | 25 |
| 5 | 19 | 23 | 25 | 25 |
| 6 | 18 | 23 | 26 | 25 |
| 7 | 17 | 23 | 25 | 26 |
| Average | 17 | 23.4 | 26.1 | 24.7 |
| Comparison | 0% | 72.6% | 65.1% | 68.8% |
| of force in % | | | | |

TABLE II
Measured Force in Ounces to Overcome
Electrostatic Attraction in Various 12 inch Wide Strips

| Test | Strips of | Strips of | Strips of FIGS. | Smooth |
|---|---|---|---|---|
| Number | FIGS. 2 - 4 | FIGS. 7 and 8 | 9 and 10 | surface strips |
| 1 | 32 | 44 | 53 | 47 |
| 2 | 35 | 46 | 70 | 49 |
| 3 | 34 | 41 | 60 | 45 |
| 4 | 33 | 44 | 63 | 54 |
| 5 | 33 | 38 | 60 | 44 |
| 6 | 33 | 38 | 59 | 41 |
| 7 | 32 | 41 | 64 | 42 |
| Average | 33.1 | 41.7 | 61.3 | 46.0 |
| Comparison | 0% | 79.4% | 54.0% | 72.0% |
| of force in % | | | | |

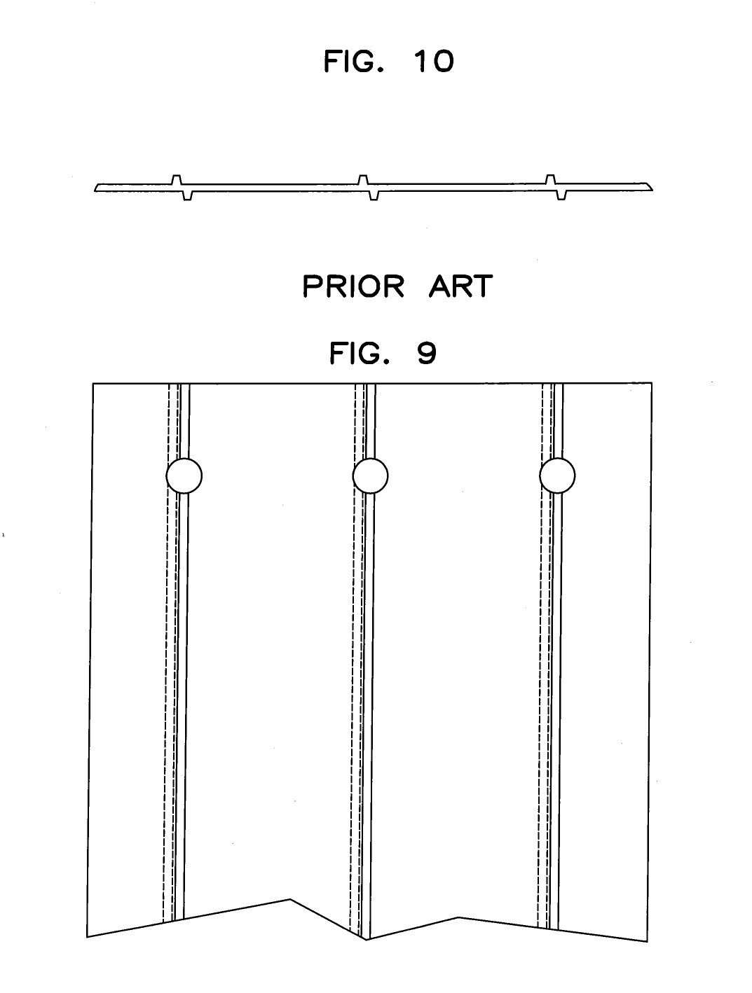

FIG. 5 is a graph of the seven trials in Table I examining the force in pounds necessary to overcome the electrostatic attraction of various 8″ wide strips forming an industrial traffic curtain 10. FIG. 6 is a graph of the seven trials in Table II examining the force in pounds necessary to overcome the electrostatic attraction of various 12″ wide strips forming an industrial traffic curtain 10. The bottom line in each graph shows the test results for the strips shown in FIGS. 2-4. The line in the graph designated by “Scratchguard Lo-Temp” shows the test results for the prior art strips shown in FIGS. 7 and 8. The line in the graph designated by “Armor Seal Lo-Temp” shows the test results for the prior art strips shown in FIGS. 9 and 10. The line in the graph designated by “Smooth Lo-Temp” shows the test results for strips of uniform cross-section having planar, parallel surfaces such as those shown in U.S. Pat. Nos. 4,095,642; 4,607,678; and 5,127,460. The tests reveal a surprising and unexpected effect of a measurably lower electro-static attraction between the strips 12 as compared to the prior art strip curtains so that the resistance to separation as goods and transporting vehicles 16 attempt to pass through the curtain 10 is much lower than prior art curtains.

It can be seen from the graphs of FIGS. 5 and 6 that a curtain formed of the strips shown in FIGS. 2-4 exhibits an electrostatic resistance to separation of only about 70% of the resistance to separation exhibited by a traffic curtain made of smooth planar curtain strips having the same width. A curtain formed of the strips shown in FIGS. 2-4 exhibits an electrostatic resistance to separation of only about 75% of the resistance to separation exhibited by a traffic curtain made of the prior art strips shown in FIGS. 7 and 8 having the same width. A curtain formed of the strips shown in FIGS. 2-4 exhibits an electrostatic resistance to separation of only about 60% of the resistance to separation exhibited by a traffic curtain made of the prior art strips shown in FIGS. 9 and 10 having the same width. This lower resistance to separation eases the traffic flow through the strip curtain without removing entirely the desirable self-closing function of the curtain that is important for the performance of the curtain as an environmental separator.

While these features have been disclosed in connection with the illustrated preferred embodiment, other embodiments of the invention will be apparent to those skilled in the art that come within the spirit of the invention as defined in the following claims.

1. Curtain door stripping for use in industrial curtain doors comprising:
a strip of flexible transparent material of substantially uniform longitudinal character having a lateral cross-section defined by an alternating series of thicker portions of a first thickness separated from each other by thinner portions of a second thickness, the thicker and thinner portions having approximately the same width, the thinner and thicker portions being united by narrower tapered regions of changing thickness,
wherein a thickness ratio of the first thickness of the thicker portions and the second thickness of the thinner portions is about 2:1.

2. The curtain door stripping of claim 1, wherein the thicker portions have a width to thickness ratio of about 10.

3. The curtain door stripping of claim 1, wherein the thinner portions have a width to thickness ratio of about 20.

4. The curtain door stripping of claim 1, wherein the tapered regions form about 20% of the lateral cross-section of the strip.

5. The curtain door stripping of claim 1, wherein each of the tapered regions comprises surfaces inclined at an angle of about 10° with respect to adjoining surfaces of the thinner and thicker portions.

6. The curtain door stripping of claim 1, further comprising edges of the lateral cross-section, wherein the edges of have the first thickness of the thicker portions.

7. An industrial traffic curtain for use as a closure for an opening, the curtain comprising:
a plurality of overlapping strips suspended contiguously to each other from a hanger fixed adjacent to a top margin of the opening, each strip consisting essentially of a strip of flexible transparent material of substantially uniform longitudinal character having a lateral cross-section defined by an alternating series of thicker portions of a first thickness separated from each other by thinner portions of a second thickness, the thicker and thinner portions having approximately the same width, the thinner and thicker portions being united by narrower tapered regions of changing thickness,
wherein edges of the lateral cross-section have the first thickness of the thicker portions.

8. The industrial traffic curtain of claim 7, wherein a measure of electrostatic resistance to separation is about 70% of a corresponding measure of electrostatic resistance to separation exhibited by a similar traffic curtain made of smooth planar curtain strips having the same width but a lateral cross-section of unchanging thickness.

9. The industrial traffic curtain of claim 8, wherein the thicker portions have a width to thickness ratio of about 10.

10. The industrial traffic curtain of claim 8, wherein the thinner portions have a width to thickness ratio of about 20.

11. The industrial traffic curtain of claim 8, wherein the tapered regions form about 20% of the lateral cross-section of the strip.

12. The industrial traffic curtain of claim 11, wherein the tapered regions surfaces are inclined at an angle of about 10° with respect to the surfaces forming the thinner and thicker portions.

13. The industrial traffic curtain of claim 8, wherein a thickness ratio between the thicker portions and the thinner portions is about 2:1.

14. An industrial traffic curtain for use as a closure for an opening, the curtain comprising:
a plurality of overlapping strips of flexible transparent material having a longitudinally uniform lateral cross-section, alternating in thickness between a thick section having a first thickness and a thin section having a second thickness,
wherein each end of the lateral cross-section has the first thickness,
wherein each thick section and each thin section is of an approximately similar lateral width,
wherein each thick section and each thin section are separated by tapered regions varying in thickness laterally between the first and the second thicknesses, and
wherein a measure of electrostatic resistance between the overlapping strips is about 70% of a corresponding measure of electrostatic resistance between a different set of overlapping strips having a smooth lateral cross-section of constant thickness.

15. The curtain door stripping of claim 14, wherein a thickness ratio of the first thickness of the thick portions and the second thickness of the thin portions is about 2:1.
